(19) United States
(12) Patent Application Publication
(10) Pub. No.: US 2012/0248740 A1
(43) Pub. Date: Oct. 4, 2012

(54) Decontamination Transport / Wheelchair

(75) Inventors: Andrew Robert Squires, Wyoming, MI (US); Ralph Arthur Spooner, Holand, MI (US)

(73) Assignee: OSD TECH LLC, Wyoming, MI (US)

(21) Appl. No.: 13/078,981

(22) Filed: Apr. 3, 2011

(51) Int. Cl. A61G 5/08

(52) U.S. Cl. 280/650

(57) ABSTRACT

A decontamination transport/wheelchair for use in conditions where a victim is contaminated not allowing acceptance to a medical facility, or where a backboard is not necessary. The chair's sections allow for full draining, cleaning and drying of the chair. The chair is comprised of chemical resistant materials and coatings. The chair has a seat and backrest with holes aiding in cleaning and security of the victim. The chair is vertically foldable minimizing storage size, and deployed in one movement. The chair has a integral forward stop and locking mechanism for the fully deployed position. The chair's brakes are operated by hand or foot. A one piece adjustable, stretchable, chemical resistant restraining strap is used to secure the victim in the chair. The chair has independent pivoting armrests. The chair has a pivoting footrest. The chair has carry handles. The chair has features for holding other medical devices.

### CROSS REFERENCE TO RELATED APPLICATIONS

Not Applicable

### STATEMENT REGARDING FEDERALLY SPONSORED RESEARCH OR DEVELOPMENT

Not Applicable

Description of Attached Appendix

Not Applicable

### BACKGROUND OF THE INVENTION

This invention relates generally to the field of transport and or wheelchairs and more specifically to decontamination transport/wheelchair.

The first modern representation for a wheelchair was made for King Phillip II of Spain in 1595. 1783 the modern wheelchair was designed, improved and refined from that point on. The first horizontally folding wheelchair was by HC Jennings in 1933. Modern wheelchairs made for sports use rigid chairs and are not collapsible. One of the refinements of wheelchairs is of a transport chair which is pushed by an attendant. The folding and locking mechanisms of current chairs have holes through the tubes which is the most convenient for pivoting actions. The attack on the World Trade Center and other events past and in the future that could threaten the medical centers with contamination has shown a need for a decontamination chair. The current chairs cost upward of $1000 to purchase and if contaminated would need to be thrown away which is cost prohibitive to the hospital.

Standard—Transport and wheelchairs are folded horizontally are lightweight and mostly rated for 250 lb individuals.
Standard wheelchairs are folded horizontally because it becomes more compact due to the large push wheels causing the material in the center to be a highly flexible material.
In one low cost chair—comfort is not a priority. Theft is a priority. Some arms are movable but are in the horizontal position during storage.
Evacuation chairs are for moving up and down stairs. Lower end does remove the stair system but still have high costs.
Chairs with adjustable systems slide within other tubes.
Chairs meant for full water events are either floating type or transfer chairs for moving a person into a standard shower.
Vertically folded systems have been shown with pin locks.
Current designs are tubular in sections which are the easiest to bend and work with and have good torsional properties.
There are some that have independently pivoting armrests in the vertical and horizontal pivoting directions.
A center located footrest has been used.
Transport chairs use smaller wheels for minimal storage size.
Restraint systems are two handed operations with seatbelt type attachments.
There are width adjustable wheelchairs and the center is a highly flexible material they are either pin stopped or gear stopped designs.
Bariatric chairs are specially designed and wider than standard chairs.
Chairs with additional handles are in the front of the chair.
The horizontal opening of wheelchairs is a two handed operation.
Horizontal opening wheelchairs with the X folding in the center does not require a lock Transport and wheelchairs have 2 pivoting wheels and 4 wheels for the best stability although some have been designed with 3 wheels.
Chairs have holes through tubing allowing fluids to be trapped and potential mold and viral growth.
Current chairs do not have holes in seat or back.
Multiple footrests require multiple movements to get in place.
Footrests are horizontally rotated using more than 1 motion for deployment.
Costs are too high for a product that may have to be incinerated under extreme contamination conditions.
Straps are cloth and not contamination free.
Attachments of the strap have areas for water to become trapped and potential mold and viral growth.
Evacuation chairs are complex and require instructions for use.
Wheel locks are small on many designs and would be difficult to use without bending.
Evacuation chair auxiliary handles are too low and require deep bending.
Evacuation chairs do not have armrests.
Straps attachments require many movements to use.
No chairs are meant for the cleaning of persons in outdoor environments.
No common transport/wheelchairs with seated holes are meant for draining cleaning fluids.
Horizontal deployments require 2 hands.
With only 2 pivoting wheels a wide bariatric chair may not get through small passageways without picking up the chair.
Chairs do not have integral holes for auxiliary additions.
Chairs do not have all chemical resistant materials.
Vertical folding chairs have additional features to hold it closed during storage and used only for that purpose.
Locks for deployment are not hands free.

### BRIEF SUMMARY OF THE INVENTION

The primary object of the invention is Use in the decontamination of victims.

Another object of the invention is chemical resistant materials are used.

Another object of the invention is designed for compact storage.

Yet another object of the invention is that it easily drains and can be fully cleaned

Still yet another object of the invention is there are no places for water to pool or be trapped.

Another object of the invention is that it can handle patients up to 500 lbs.

Another object of the invention is that it can easily transfer a patient to the chair from other positions.

A further object of the invention is to restrain patients quickly.

Another object of the invention is to quickly and easily deploy the chair.

Another object of the invention is to allow for carrying if necessary.

Yet another object of the invention is to aid in the washing of the victim.

Yet another object of the invention is to help the victim from sliding in the chair.

Another object of the invention is to allow for easy manipulation of the chair with patient.

Another object of the invention is to allow the operator to use their feet or hands for manipulating parts of the chair.

Another object of the invention is to accommodate other accessories such as a head rest, IV hanger, oxygen canisters, personal items carrier.

Still yet another object of the invention is to allow for the components to be easily replaced if needed.

Another object of the invention is to maximize the ability to push and turn the chair in all directions.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a Decontamination transport/wheelchair comprising: 4 wheels, Said wheels have a minimum of 2 that pivot allowing for the turning of the chair, In alternate constructions all 4 wheels can pivot allowing for the chair to be pushed or pulled in any direction. Said chair comprises open or fully sealed sections, Said sections allow for draining drying and cleaning of the chair materials capable of withstanding 500 lbs occupants, made from chemical resistant low cost materials, processes and coatings. A rigid seat, Said seat contains holes aiding in the cleaning of the victim. Said seat contains holes aiding in the resisting of the occupant from sliding. In alternate embodiments said seat can be made from non-rigid materials. A rigid backrest, said backrest has integral hooks for the attachment of straps. Said backrest has holes aiding in the cleaning of the victim. In alternate embodiments said backrest can be made from non-rigid materials. Said chair has vertically foldable mechanisms. Said foldable mechanisms pivots to create a minimum storage size. Said foldable mechanisms deploys easily in one movement. Said chair has a locking mechanism, Said locking mechanism comprising: A return spring, hooked arm(s), an offset pivot, a release handle, a lip for the hooked arm(s). Said return spring rotates the hook to the locked position. Said hooked arm(s) engage the said lip in the locked position. Said pivot is offset from the lip. Said release handle must overcome the spring force to release the lock. Said release handle is positioned such that the lock cannot be easily inadvertently released. In alternate constructions the hook could engage on a post instead of a lip. In alternate constructions a spring loaded mechanism could lock the seat to the chair. The said chair has an Integral forward stop, Said Integral forward stop comprising, A seat pivot, Seat bracket, Seat structure, Back stop, Said seat structure when pivoted to the prescribed open position on the back stop, keeping the seat from opening beyond that position. Said back stop will not allow the seat from rotating further than 90 degrees from the seat back preferably less than 90 degrees. Said chair contains lightweight materials, Said Brakes can be operated by hand or foot, Said chair contains a restraining strap, Said restraining strap is made of a chemical resistant material. Said restraining strap is made of one piece. In alternate constructions it could be made of multiple pieces. Said restraining strap is pliable to secure the victim without undue stress. Said restraining strap has a hole for attachment to the chair. Said restraining strap has holes to engage with the integral hook on the chair. In alternate constructions a hook can be placed in other appropriate positions on the chair, Said restraining strap has a length that will accommodate encompassing small and large victims. Said restraining strap can be used to hold the chair in the folded stored position. Said chair has vertically pivoting armrests. Said armrests pivot minimizing storage space. Said armrests stay in the stored position unless acted upon by the operator or victim. Said armrests pivot aiding in victim security and comfort. Said armrests pivot independently. Said chair contains a pivoting footrest, Said footrest pivots minimizing storage space. Said footrest stays in the stored position unless acted upon by the operator or victim. Said footrest stays in the stored position aiding in victim transfers. In an alternate construction of the footrest, it can be fixed and in a position where it would not be easily stood on which could cause the chair to tip while entering or exiting the chair. Said chair contains rounded edges, Said chair incorporates carry handles. Said carry handles are firmly integrated to the chair. Said carry handles withstand the lifting of 500 lb occupants. In alternate embodiments the handles can be deployed horizontally by pivoting or sliding. Said chair contains integral features for holding oxygen canisters, IV's, a bag for personal affects, and an optional head rest.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a front perspective view of the invention showing the major components.

FIG. 2 is a rear perspective view of the invention showing the major components.

FIG. 3 is a bottom perspective view of the invention showing the locks and pivots of the chair.

FIG. 4 is a bottom perspective view of the invention showing the open sections of the chair.

FIG. 5 is a view of the invention in its folded condition.

FIG. 6 is a perspective view of the invention showing the individual folded armrests and footrest.

FIG. 7 is a perspective view of the locking mechanism of the invention.

FIG. 8 is a detailed plan view of the locking mechanism.

FIG. 9 is a detailed view of the optional folding armrest

FIG. 10 is view of the fixed footrest on a non-folding version of the chair

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

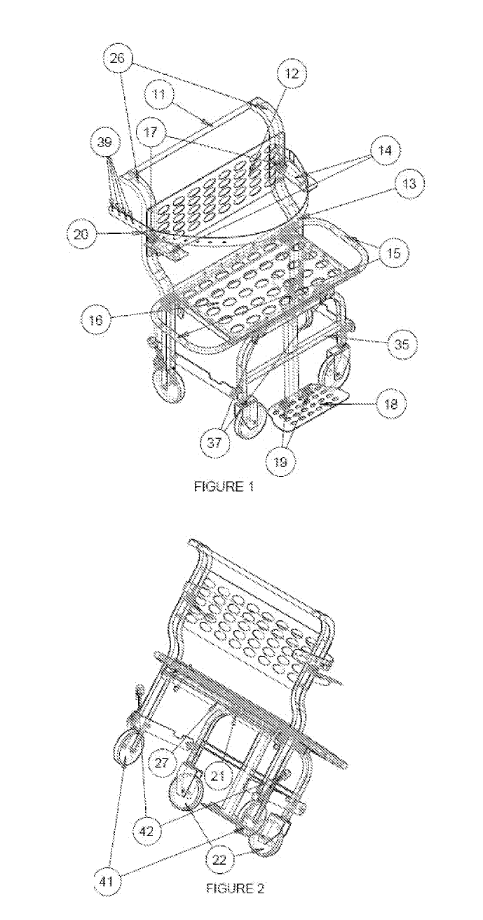

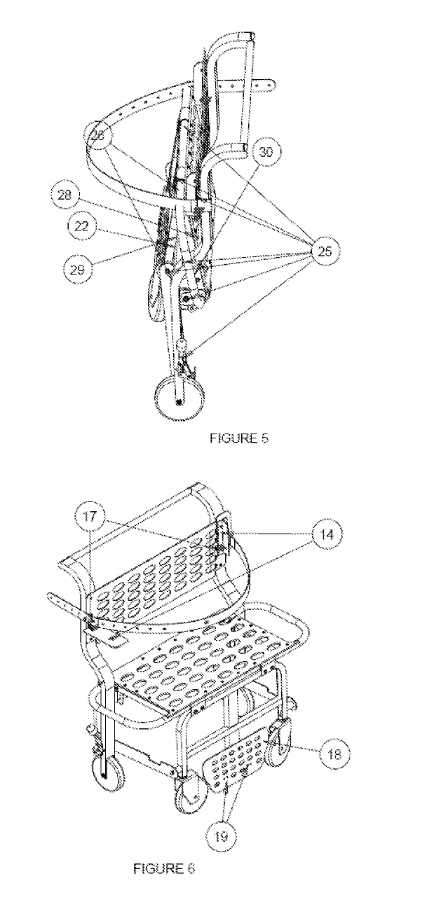

Turning first to FIGS. 1,2 and 4 there are shown a perspective views showing the full view of the decontamination transport/wheelchair which will be referred as chair throughout this description. The chair, made from low cost chemical resistant materials and materials strong enough to transport occupants up to 500 pounds, for decontamination of victims in emergency conditions, has a pushbar 11 connecting to two upright rear channels 26 these channels are of open sections 31 for ease of cleaning and efficiency of drying. The upright rear channels 26 are also connected by a rear weldment 27. A backrest 12 with holes to aid in the ability to clean occupants of the chair is attached to the upper vertical section of the upright rear channels 26. The seat 16 is attached to the seat weldment 15 made of fully sealed and open sections 31 for ease of cleaning and efficiency of drying. The seat 16 with holes to aid in the ability to clean occupants of the chair and reducing the ability of the occupant to slide while sitting in the seat 16. Alternately texturing the seat can also aid in reducing the ability of the occupant to slide while sitting in the seat 16. The seat 16 and seat weldment 15 are connected by the means of bolts through the holes in the seat stop 32 and rear weldment 27 allowing for the seat to pivot vertically. A front weldment 35 is made of open sections 31 for ease of cleaning and efficiency of drying, is attached to the seat weldment 15 by the means of bolting u-pivot 37 over front bearing 36 and seat weldment 15 through holes in the front weldment 35 creating the front seat pivots 38. Constraining the system together, two four-bar linkages 23 are bolted to both the front weldment 35 and upright rear channels 26 creating pivots 40 for vertically folding the chair for storage FIG. 5. The chair being vertically foldable is held in the folded position by the restraining strap 13, to discussed in full later in the description, until released from the front weldment 35 allowing the chair to open by the use of gravity with no extra effort and quickly by the operator until the latch hooks 26 engage the rear weldment lip 29 and the seat stop 32 and seat weldment 15 engages with the upright rear channel 26 restrains the pivoting of the seat. Lock and stop details to be discussed in full in later sections.

Referring to FIGS. 1, 5 and 6 the armrests 14 are assembled to the upright rear channels 26 by the means of detent or friction hinges 17 allowing for the control of the armrest 14 and ease of patient transfer. Upon deployment of the chair, the armrests 14 are held in position by the detent or friction hinges 17 keeping the armrests 14 out of the way until needed. In an alternate construction the armrests 14 are held in the upright position by friction of the bolt 47 and or the over-center position of the armrest while in storage. Additionally a footrest 18 is connected to the front weldment 35 by the means of detent or friction hinges to the t-section of the front weldment 35 allowing for control of the footrest 18 and ease of patient transfer. Upon deployment of the chair, the footrest 18 is held in position by the detent or friction hinge 17 until the transfer of the patient is completed. In an alternate construction the fixed footrest 50 is attached to a center vertical post keeping the person from inadvertently tipping the chair while entering or exiting the chair. A restraining strap 13 for assisting in patient control is attached to the upright rear channels 26 and attached to the backrest 12 to the integrated strap attachment feature 20 through any of the strap attachment holes 39 allowing for one handed simple and expedient securement of the patient. Attaching to the front weldment 35 are two pivoting wheels 22 to allow for the turning of the chair. Attaching to the upright rear channels 26 are 2 stationary wheels 41 connected by a bolt through the rear channel 26 allowing for rolling of the wheel. Although this embodiment shows only two pivoting wheels 22 in alternate constructions four pivoting wheels 22 can be an advantage by allowing the chair to be pushed in any direction to move into tighter spaces, The final attachment to the upright rear channels 26 are brakes 42 which are bolted to the rear upright channels 26 at a position where when engaged, by hand or foot, the brake 42 will interfere with stationary wheel 41 stopping the wheel from turning allowing for added control of the chair. In the alternate embodiment with four pivoting wheels 22 the brake may be incorporated into the pivoting wheel system 22.

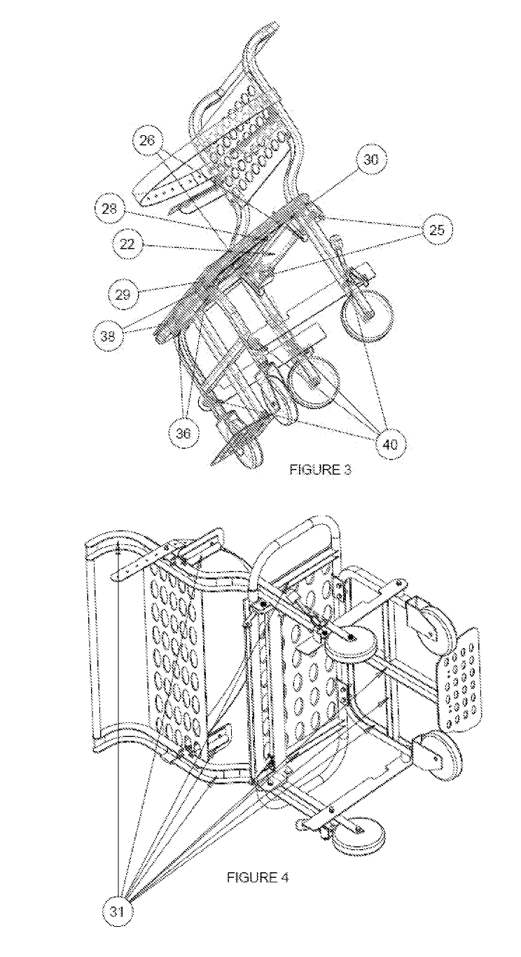

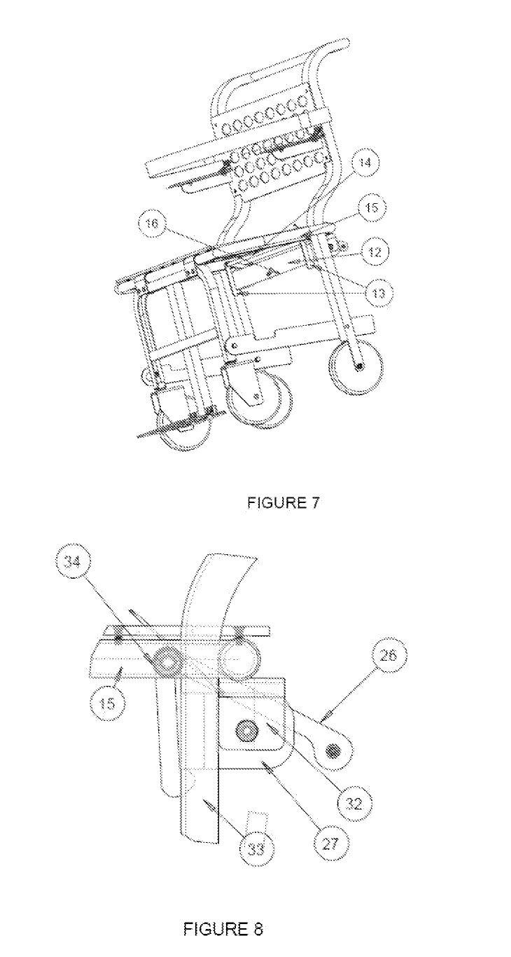

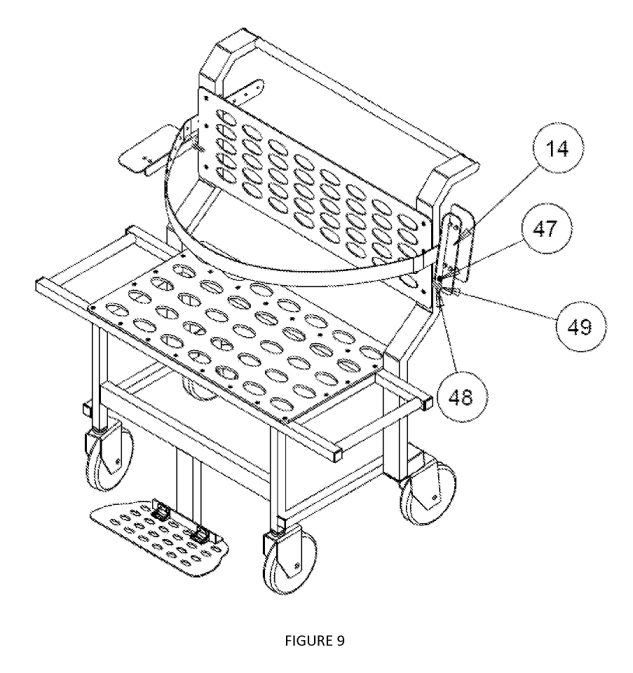

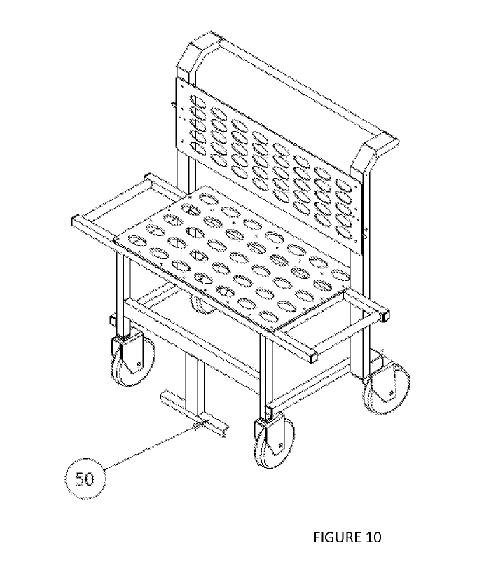

Referring to FIGS. 2, 3, 7, and 8, The chair comprises a lock system comprising a lock handle 21 connected to two latch hooks 26 and a latch pivot bar 28 between the latch hooks 26. The lock system pivots within the seat weldment 15 at a position forward of the rear weldment 27 creating an over-center latch when the latch hooks 26 are forced by torsion spring 34 to move over the rear weldment lip 29. In alternate embodiments, latch hooks 26 can engage a post or the latch hooks 26 can engage a spring loaded pin or the like. The latch hooks 26 will continue to stay over the rear weldment lip 29 until the lock handle 21 is pushed with sufficient force to overcome the torque applied by torsion spring 34 allowing the chair to be vertically folded for storage. The lock system is of sufficient strength to allow for a 500 lb person to be tilted rearward when the pushbar 11 is pulled rearward without failing. The chair comprises an integral stop using both the seat stop 32 and seat weldment 15 engaging with the upright rear channel 26 not allowing the seat 16 to rotate beyond a designed angle which would be at an angle of 90 degrees or less giving the occupant a secure feeling of not falling out of the chair. In the use/deployed condition the seat weldment 15 extends beyond the seat 16 allowing for the chair to be picked up allowing emergency personnel to negotiate obstacles where the chair cannot roll over such as curbs, ditches, deep snow or soft ground. The height of the seat weldment 15 is designed to a height that is ergonomically positioned giving the best leverage for the emergency personnel to pick up the chair with ease and minimal bending, unlike other chairs in the market.

All major chair components backrest 12, seat 16, armrests 14, footrest 18, seat weldment 15, front weldment 35 and wheels 41 and 22 can be replaced or cleaned and re-assembled in case of damage. The chair has integrated features for the addition of IV holders 43, oxygen canister holders 44, personal effects holder 45, and optional headrest 46. Other additional features or products not mentioned here may also be added to the without affecting the function of the chair.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Decontamination transport/wheelchair comprising:
4 wheels
Said wheels allow for the maximizing the stability of the chair
Said wheels have a minimum of 2 wheels that pivot for turning
Alternately all 4 wheels can pivot allowing for sideways movement of the chair
Open or fully sealed sections;
Said sections allow for draining drying and cleaning of the chair
Materials capable of withstanding 500 lbs occupants;
Chemical resistant materials and coatings;
Low cost materials and processes
A rigid seat;
Said seat contains holes aiding in the cleaning of the victim.
Said seat contains holes aiding in the resisting of the occupant
A rigid backrest;
Said backrest has integral hooks for the attachment of straps.
Said backrest has holes aiding in the cleaning of the victim.
Vertically foldable mechanisms;
Said foldable mechanisms pivots to create a minimum storage size.
Said foldable mechanisms deploys easily in one movement.
A locking mechanism;
Said locking mechanism comprising:
A return spring;
Hooked arm(s);
An offset pivot;
A release handle;
A lip for the hooked arm(s);
Said return spring rotates the hook to the locked
Said hooked arm(s) engage the said lip in the locked
Said pivot is offset from the lip.
Said release handle must overcome the spring force
Said release handle is positioned such that the lock
In alternate constructions the hook could
In alternate constructions a spring loaded
Integral forward stop;
Said Integral forward stop comprising;
A seat pivot;
Seat bracket;
Seat structure;
Back stop;
Said seat structure when pivoted to the prescribed open position on the back stop, keeping the seat from opening beyond that position.
Said back stop will not allow the seat from rotating further than 90 degrees from the seat back preferably less than 90 degrees.
m Lightweight materials;
Brakes operated by hand or foot;
A restraining strap;
Said restraining strap is made of a chemical resistant material.
Said restraining strap is made of one piece.
In alternate constructions it could be made of multiple Said restraining strap is pliable to secure the victim without undue Said restraining strap has a hole for attachment to the chair.
Said restraining strap has holes to engage with the integral hook on the chair.
In alternate constructions a hook can be placed in other
Said restraining strap has a length that will accommodate
Said restraining strap can be used to hold the chair in the folded Pivoting armrests;
Said armrests pivot minimizing storage space.
Said armrests stay in the stored position unless acted upon by the
Said armrests pivot aiding in victim security and comfort.
Said armrests pivot independently.
Pivoting footrest;
Said footrest pivots vertically minimizing storage space.
Said footrest stays in the stored position unless acted upon by the
Said footrest stays in the stored position aiding in victim transport.
Rounded edges;
Carry handles;
Said carry handles are firmly attached to the chair.
Said carry handles withstand the lifting of 500 lb occupants.
Features for holding oxygen canisters;
Features for holding IV's;
Features to hold a bag for personal affects;
Features for adding a headrest;
